(19) United States
(12) Patent Application Publication
(10) Pub. No.: US 2019/0390030 A1
(43) Pub. Date: Dec. 26, 2019

(54) HYBRID POLYURETHANE FOAM AND METHODS OF MANUFACTURE

(71) Applicant: O2 Partners, LLC, Amherst, MA (US)

(72) Inventor: Hanson Zhang, Dongguan City (CN)

(21) Appl. No.: 16/018,681

(22) Filed: Jun. 26, 2018

(51) Int. Cl. C08J 9/35; B29C 44/04; B29C 44/56; B29C 44/08; B29D 35/12; B29C 44/34; A43B 17/00; A43B 1/14; A43B 17/14

(52) U.S. Cl. CPC C08J 9/35; B29C 44/04; B29C 44/56; B29C 44/08; B29D 35/122; B29K 2075/00; A43B 17/003; A43B 1/14; A43B 17/14; C08J 2375/04; B29C 44/3442

(57) ABSTRACT

The present invention is for open cellular polyurethane foam comprising virgin foam and previously cured foam, methods of making the same, as well as inner soles for footwear made therefrom.

### BACKGROUND OF THE INVENTION

Open cellular polyurethane foam (open cel PU) is a rubber-like product made by incorporating a blowing agent into a rubber-like compound. The blowing agent gives off a gas that expands the open cel PU during the vulcanization or curing process. Open cel PU is typically made from two primary ingredients, isocyanate and polyol. Foam density is controlled by the ratio of ingredients with a higher ratio of inflating agent to open cel PU resulting in a lower density foam. Shape and size of the foam produced is controlled by the shape and size of the mold used to form the foam.

Open cel PU foam is used for in the manufacture of many items including high-resilience foam seating, rigid foam insulation panels, microcellular foam seals and gaskets, durable elastomeric wheels and tires (such as shopping cart and skateboard wheels), automotive suspension bushings, electrical potting compounds, high performance adhesives, surface coatings and surface sealants, synthetic fibers (e.g., Spandex), carpet underlay, hard-plastic parts (e.g., for electronic instruments) and hose. The resilient nature of open cel PU foam makes it ideal for use as an inner sole for footwear. However, the manufacture of open cel PU foam inner soles results in considerable waste as inner soles must be cut to specific sizes and shapes. This creates an environmental issue as the waste material is slow to degrade and breakdown. Therefore, what is needed are new foam compositions and methods of manufacture that reduce the amount of waste foam that is put into the waste stream.

### SUMMARY OF THE INVENTION

The present invention is directed towards new materials and methods of manufacture for open cel PU foam inner soles that reduce the amount of waste foam to be put into the waste stream. In brief, the present invention incorporates a percentage of scrap foam (i.e., previously cured foam) that has been ground into pellets (herein defined as small, randomly shaped pieces of foam) and then blended into the polyol, isocyanate mixture before the polyol and isocyanate have reacted to form open cel PU foam, thereby incorporating scrap foam into the virgin foam. It is believed by the inventors that this process has not been used before this invention in the production of inner soles due to concerns with regard to the resilience and durability of the open cel PU foam being made comprising previously cured foam. It is believed by the inventors that this was a concern because inner soles undergo extensive compression and flexing during use and it was thought that the material may separate at the junctures between the virgin and old, previously cured foam. Surprisingly and unexpectedly, the inventors found that inner soles made from this process are not compromised in any way and are as resilient and durable as inner soles made from 100% virgin open cel PU foam. The result of this co-mingling of material (virgin and previously cured) will also have a unique visual difference compared to that of a virgin open cel PU compound. The previously cured material will randomly appear as inconsistent shaped specks or flecks of material that can be either color consistent (to the virgin foam) or have the appearance of multicolored specks or flecks contrasting to the natural virgin color.

In one aspect, the invention is directed towards an inner sole for footwear comprising, consisting essentially of or consisting of open cellular polyurethane foam, wherein said open cellular polyurethane foam is made from isocyanate and polyol to form virgin open cellular polyurethane foam and about 1% to about 20% by weight of previously cured open cell polyurethane foam. In another aspect of the invention the inner sole comprises from about 80% to about 99% by weight virgin open cellular polyurethane foam and from about 1% to about 20% by weight of the previously cured open cellular polyurethane foam. In yet another aspect of the invention the inner sole comprises about 5% to about 15% by weight of the previously cured open cellular polyurethane foam. In yet another aspect of the invention the previously cured cured open cellular polyurethane foam is ground into pellets no longer than about 1.0 mm to about 2.5 mm in the longest direction.

The present invention also contemplates a method of making open cellular polyurethane foam containing previously cured open cellular polyurethane foam, the method comprising, consisting essentially of or consisting of: a. providing i) isocyanate, ii) polyol and iii) previously cured open cellular polyurethane foam pellets; b. mixing the isocyanate, polyol and previously cured open cellular polyurethane foam pellets until said pellets are substantially disbursed in the isocyanate and polyol to create a mixture; c. putting the mixture into a first mold until the mixture is cured, to create an open cellular polyurethane foam comprising virgin and previously cured open cellular polyurethane foam; and d. i) cutting the open cell polyurethane foam comprising virgin and previously cured open cellular polyurethane foam into a desired shape and/or ii) molding the open cellular polyurethane foam comprising previously cured open cellular polyurethane foam into a desired shape in a second mold. In another aspect of the invention the previously cured open cellular polyurethane foam pellets are added to the isocyanate and polyol at about 1% to about 20% by weight. In yet another aspect of the invention, the previously cured open cellular polyurethane foam pellets are added to the isocyanate and polyol at about 5% to about 15% by weight. In still yet another aspect of the invention, the previously cured open cellular polyurethane foam is ground into pellets no longer than about 1.0 mm to about 2.5 mm in the longest direction. In yet another aspect of the invention, the virgin open cellular polyurethane foam comprising previously cured open cellular polyurethane foam is cut or molded into one or more inner soles for footwear. In yet another aspect of the invention, the mixture further comprises agents selected from the group consisting of one or more colors, one or more chain extenders and one or more blowing agents.

### DESCRIPTION OF THE FIGURES

FIG. 1 shows a photograph of the bottom of a cut and molded inner sole for footwear made from the virgin open cellular polyurethane foam comprising cured polyurethane foam pellets. The cured foam is visible as speckling. A photograph is provided, a photograph being the only practical medium for illustrating the claimed invention.

### DETAILED DESCRIPTION OF THE INVENTION

Various embodiments of the invention will now be explained in greater detail. It is to be understood that both the foregoing general description and the following detailed description are exemplary and explanatory only, and are not restrictive of the invention as claimed. Any discussion of certain embodiments or features serves to illustrate certain exemplary aspects of the invention. The invention is not limited to the embodiments specifically discussed herein.

Unless otherwise indicated, all numbers such as those expressing temperatures, weight percent, concentrations, time periods, dimensions, and values for certain parameters used in the specification and claims are to be understood as being modified in all instances by the term “about,” unless clearly stated otherwise. It should also be understood that the precise numerical values and ranges used in the specification and claims form additional embodiments of the invention.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. Instead, the proper scope of the embodiments is defined by the appended claims. Further, stating that a feature may exist indicates that the feature may exist in one or more embodiments.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value and all values between, regardless as to if they have been explicitly identified. Similarly, when values are expressed as approximations, by use of the antecedent “about,” it will be understood that the particular value forms another embodiment.

In this disclosure, the terms “include,” “including,” “comprise,” “comprising,” “contain,” “containing,” “have,” and “having” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, up to and including all members of the set.

The phrase “consisting of” excludes any element, step or ingredient not specified in the claim. The phrase “consisting essentially of” limits the scope of a claim to the specified materials or steps and materials or steps that do not materially affect the basic and novel characteristics of the claimed invention, as defined in MPEP 2111.03, II. It is clear from this specification which elements do and do not materially affect the basic and novel characteristics of the claimed invention. Further, any elements recited in a dependent claim, even though further limiting, are not considered to be essential to the elements recited in the identified independent claim. The present disclosure contemplates embodiments of the invention compositions and methods corresponding to the scope of each of these phrases. Thus, a composition or method comprising recited elements or steps contemplates particular embodiments in which the composition or method consists essentially of or consists of those elements or steps.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

The production of open cellular polyurethane (open cel PU) foam is well known in the art and its use is well known in the manufacture of shoe components. General descriptions of the process of making polyurethane including open cel PU urethane can be found on the internet. See, for example, en.wikipedia.org/wiki/Polyurethane. See, also, US Patent Publication Nos. 2007/0142489 and 2018/0103718, both incorporated herein by reference. The present invention is not limited to a specific process for the manufacture of open cel PU foam providing that the resulting product meets the requisite foam density and contains the requisite percent of previously cured open cel PU foam as specified herein.

In brief, open cel PU foam is made by combining two primary ingredients, isocyanate and polyol, and allowing them to react in a sealed mold of desired size. The polyurethane is produced by the reaction between the isocyanate containing two or more isocyanate groups per molecule (R—(N═C═O)n) with the polyol containing on average two or more hydroxyl groups per molecule (R′—(OH)n) in the presence of a catalyst or by activation with ultraviolet light. One of ordinary skill in the art can select one or more suitable isocyanates and one or more polyols for the production of open cel PU foam. Foams can be made, for example, by adding water to the mixture. The isocyanate reacts with the water to form a urea linage and carbon dioxide gas. The reaction can be further catalyzed by tertiary amines like bis-(2-dimethlyaminoethyl) ether. This reaction is referred to as a blowing reaction and the water is the blowing agent. The balance between the gelation and blowing is what determines the flexibility and density, respectively, of the resulting foam.

The density of foams of the present invention typically range from about 2 lb/ft³-about 20 lb/ft³ or about 2 lb/ft³-12 lb/ft³. Although open cel PU foam is preferred, other open cell foams may be used in the present invention. Representative types of open cell foam are polyurethane, foam rubber, silicon, polyether, polyester, etc.

Ingredients in addition to isocyanates and polyols may be used in the manufacture of open cel PU foam. For example, one or more blowing agents, one or more catalysts and one or more chain extenders may also be used in manufacturing the inner open cel PU foam of the present invention.

Exemplary blowing agents include water, which may be used alone or water may be used together with a hydrocarbon, a chlorofluorocarbon, or a hydrogenated fluorocarbon, as is known to one of ordinary skill in the art.

Exemplary catalysts include TEDA [1,4-diazabicyclo[2.2.2]octane], N,N,N′,N′-tetramethylhexamethylenediamine, N,N,N′,N′-tetramethylpropylenediamine, N,N,N′,N′,N″-pentamethyldiethylenetriamine, trimethylaminoethylpiperazine, N,N-dimethylcyclohexylamine, N,N-dimethylbenzylamine, N-methylmorpholine, N-ethylmorpholine, triethylamine, tributylamine, bis(dimethylaminoalkyl)piperazines, N,N,N′,N′-tetramethylethylenediamine, N,N-diethylbenzylamine, bis(N,N-diethylaminoethyl)adipate, N,N,N′,N′-tetramethyl-1,3-butanediamine, N,N-dimethyl-.beta.-phenylethylamine, 1,2-dimethylimidazole, 2-methylimidazole, and the like. These catalysts can be used alone or in admixture of two or more kinds. Among these catalysts, the tertiary amines are preferable from the viewpoint of an increasing reaction rate. A catalyst other than an amine-based catalyst, for example, an organometallic compound such as dibutyltin dilaurate, stannous oleate, cobalt naphthenate, or lead naphthenate may be also used.

Exemplary chain extenders include polyhydric alcohols such as ethylene glycol, diethylene glycol, propylene glycol, 1,4-butanediol, 1,5-pentanediol, methylpentanediol, 1,6-hexanediol, trimethylolpropane, glycerol, pentaerythritol, diglycerol, dextrose, and sorbitol; aliphatic polyamines such as ethylenediamine and hexamethylenediamine; aromatic polyamines; alkanolamines such as diethanolamine, triethanolamine, and diisopropanolamine; modified products thereof; and the like. Those chain extenders can be used alone or in admixture of two or more kinds. A preferred chain extender includes ethylene glycol, diethylene glycol, 1,4-butanediol, pentaerythritol, and modified products thereof, each having a number-average molecular weight of 1,000 or less.

The present invention is directed towards, in an embodiment, the incorporation of previously cured open cel PU foam (cured foam) in to the isocyanate/polyol mixture prior to catalyzing the reaction to form virgin open cel PU foam (virgin foam). In this way, the previously cured open cel PU foam is incorporated into the virgin foam. In one embodiment, the density of the previously cured foam and the virgin foam are the same or essentially the same. In another embodiment, the densities of the previously cured foam and the virgin foam are within 1 lb/ft³, within 2 lb/ft³, with in 3 lb/ft³ or within 5 lb/ft³ or more of each other. In another embedment, the percent previously cured foam to the percent virgin foam (cured:virgin) is from about 1%:99% to about 20%:80%, inclusive of all values within the given range. In a preferred embodiment, the previously cured open cel PU foam used in the invention is of the same composition as the virgin open cel PU foam into which it will be incorporated. In another embodiment, the previously cured foam is of a different open cel PU foam composition. In yet another embodiment, the mixture may comprise up to about 5% or up to about 10% of other forms of previously cured or recycled foam (e.g., closed cell foam) or rubber.

The previously cured foam is provided in “pellets,” herein defined as small, randomly shaped pieces of foam. The pellets of the present invention are no longer than about 0.5 mm to about 3.0 mm or about 1.0 mm to about 2.5 mm in the longest direction.

The present invention comprises, in one embodiment, formulating the ingredients (base formulation) in combination with the previously cured foam pellets and placing the mixture in a sealed steel mold. Typically, the pellets are mixed in the base formulation for about 5 to about 8 minutes, however, the present invention is not limited to any particular time so long as the pellets are dispersed substantially homogenously. The reaction time to form the virgin foam containing the previously cured foam is typically 20 to 30 minutes for a 1.1 meter×2.0 meter×126 mm mold, depending on the density and hardness of the finished product. Reaction times may vary also depending on the size of the mold. The present invention is not limited to any particular reaction time so long as it is sufficient for the foam to form. One of ordinary skill in the art will be able to determine the appropriate time when guided by the teachings of this specification.

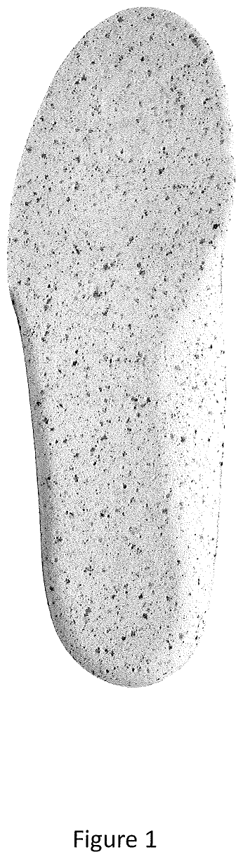

The resulting foam, comprising virgin foam interspersed with previously cured foam pellets and referred to as a “bun,” is allowed to cool until ambient temperature is reached throughout the foam. Actual cooling time is dependent on the size of the bun and density of the foam and may take up to about 24 hours. The edges of the bun can be firmer than the core of the bun and may be trimmed, if desired. The foam the sheets can then cut into specific shapes. For example, a layer can be sliced off and cut into the shape of a flat inner sole for footwear. Also, a block can be cut off of the bun and placed into a secondary mold to create a specific “molded inner sole” that has contours mirroring the bottom of a foot and the internal shape of the shoe for which it is designed. If the previously cured foam used is different in color from the virgin foam, the previously cured foam pellets will be visible as speckles to the user (see, FIG. 1).

We claim:

1. An inner sole for footwear comprising open cellular polyurethane foam, wherein said open cellular polyurethane foam is made from isocyanate and polyol to form virgin open cellular polyurethane foam and about 1% to about 20% by weight of previously cured open cell polyurethane foam.

2. The inner sole of claim 1, wherein said inner sole comprises from about 80% to about 99% by weight virgin open cellular polyurethane foam and from about 1% to about 20% by weight of the previously cured open cellular polyurethane foam.

3. The inner sole of claim 1, wherein said inner sole comprises about 5% to about 15% by weight of the previously cured open cellular polyurethane foam.

4. The inner sole of claim 1, wherein said previously cured open cellular polyurethane foam is ground into pellets no longer than about 1.0 mm to about 2.5 mm in the longest direction.

5. A method of making virgin open cellular polyurethane foam comprising previously cured open cellular polyurethane foam, the method comprising:
a. providing i) isocyanate, ii) polyol and iii) previously cured open cellular polyurethane foam pellets;
b. mixing the isocyanate, polyol and previously cured open cellular polyurethane foam pellets until said pellets are substantially disbursed in the isocyanate and polyol to create a mixture;
c. putting the mixture into a first mold until the mixture is cured, to create a virgin open cellular polyurethane foam comprising previously cured open cellular polyurethane foam; and
d. i) cutting the virgin open cell polyurethane foam comprising previously cured open cellular polyurethane foam into a desired shape and/or ii) molding the virgin open cellular polyurethane foam comprising previously cured open cellular polyurethane foam into a desired shape in a second mold.

6. The method of claim 5, wherein said previously cured open cellular polyurethane foam pellets are added to the isocyanate and polyol at about 1% to about 20% by weight.

7. The method of claim 5, wherein said previously cured open cellular polyurethane foam pellets are added to the isocyanate and polyol at about 5% to about 15% by weight.

8. The method of claim 5, wherein said previously cured open cellular polyurethane foam pellets are no longer than about 1.0 mm to about 2.5 mm in the longest direction.

9. The method of claim 5, wherein the virgin open cellular polyurethane foam comprising previously cured open cellular polyurethane foam is cut and/or molded into one or more inner soles for footwear.

10. The method of claim 5, wherein the mixture further comprises agents selected from the group consisting of one or more colors, one or more chain extenders and one or more blowing agents.
